(19) United States
(12) Patent Application Publication
(10) Pub. No.: US 2008/0149264 A1
(43) Pub. Date: Jun. 26, 2008

(54) Method for Making Flameproof Environmentally Friendly Artificial Leather

(76) Inventors: Chung-Chih Feng, Kaohsiung (TW); Pei-Huo Huang, Kaohsiung (TW); Yong-Song Lin, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/046,541

(22) Filed: Mar. 12, 2008

Related U.S. Application Data
(63) Continuation-in-part of application No. 10/984,034, filed on Nov. 9, 2004.

(51) Int. Cl. B29C 65/48

(52) U.S. Cl. 156/247

(57) ABSTRACT

A method for making a flameproof environmentally friendly artificial leather includes preparing a flameproof polyurethane resin compound by mixing chlorine-free flameproof agent with an oil-based polyurethane resin having 50%-98% by weight of solid content and a curing agent. A first polyurethane resin composition is coated on a releasing paper to form a surface layer. The flameproof polyurethane resin compound is coated on the surface layer to form a flameproof layer with thickness of 0.1 mm to 3 mm. A second polyurethane resin composition is coated on the flameproof layer to form an adhesive layer. A substrate is adhered on the adhesive layer to form an environmentally friendly artificial semi-product. The releasing paper is peeled from the surface layer to form the flameproof environmentally friendly artificial leather.

### CROSS REFERENCE TO RELATED APPLICATION

This is a continuation-in-part application of U.S. patent application Ser. No. 10/984,034 filed Nov. 9, 2004.

### BACKGROUND OF INVENTION

The present invention relates to a method for making a flameproof environmentally friendly artificial leather.

Referring to FIG. 1, a conventional method for making realistic artificial leather includes two sub-routines. The first sub-routine is called a “dry process” 100. The second sub-routine is called a “wet process” 101. The dry process 100 includes two parts 102 and 104. Firstly, releasing paper is coated with dry polyurethane resin compound to form a dry polyurethane resin layer with thickness of 0.02 mm to 0.03 mm (part 102). Then, the dry polyurethane resin layer is coated with polyurethane resin compound to form an adhesive layer with thickness of 0.04 mm to 0.05 mm (part 104). The wet process 101 includes parts 106 to 112. Firstly, a substrate is submerged in a soaking polyurethane resin compound to form a submerged layer in the substrate (part 106). Secondly, a coating polyurethane resin compound is coated on the substrate (part 108). Thirdly, the coating is coagulated (part 110). Fourthly, the coating is washed (part 112). Thus, a foam layer is formed on the substrate. Then, the adhesive layer of the product of the dry process 100 is adhered to the foam layer of the wet process 101 (part 114). Finally, the releasing paper is removed (part 116). Thus, realistic artificial leather is made.

However, the dry polyurethane resin and adhesive polyurethane resin used in the dry process 100 and the soaking polyurethane resin and coating polyurethane resin used in the wet process 101 all contain a large amount of organic solvent such as methyl ethyl ketone (MEK), N, N-dimethylformamide (DMF) and toluene (TOL).

When the dry polyurethane resin layer is formed and when the adhesive layer is coagulated, a process of drying must be undertaken to vaporize the organic solvent originally contained in the compound. The submerged layer and the foam layer must be submerged in organic solvent and water alternately so that the organic solvent is dissolved in the water and recycled. The organic solvent is a poison that is chronically hazardous to human bodies and a pollutant to the environment. The organic solvent is easily flammable and can easily be set on fire when handled carelessly.

Currently, to obviate the problem of the pollution by the organic solvent, the water-based polyurethane resin layer coated on the releasing paper is directly adhered to non-woven cloth or woven cloth. However, the resultant artificial leather does not possess the thickness and elasticity of genuine leather and, thus, provides a lousy feel and durability. Further, the resultant artificial leather does not provide the touch of genuine leather. Moreover, to improve the feel of the artificial leather made of the water-based polyurethane layer, the water-based polyurethane layer coated on the releasing paper is directly adhered to the wet half-product of the artificial leather with the foam layer. However, a large amount of organic solvent is still used in the process for making the wet semi-product of the artificial leather such as the wet process 101. Although the process for making the adhesive layer of the artificial leather is environmentally friendly, environmental pollution still occurs because a large amount of organic solvent is still used in the process for making the wet semi-product of the artificial leather.

Furthermore, because a large amount of organic solvent is used in the process, the artificial leather generally contains organic residual. Additionally, because the polyurethane resin is flammable, the artificial leather is not flameproof and can be burned when in contact with fire. Since much artificial leather is used in furniture, medical equipment, and vehicle interiors, there is an urgent need for flameproof artificial leather for the safety of users.

Generally, chlorine is added to polyurethane resin to improve the flame-resistance of artificial leather. However, chlorine is poisonous so that the cost of environmental protection is high in making, using, recycling and burning the artificial leather. Therefore, artificial leather with added chlorine is to be phased out.

Further, although chlorine-free flameproof agent is added to a water-based polyurethane resin compound in a conventional method for making a flameproof artificial leather, some problems still exist. For example, the conventional flameproof artificial leather is not made of high solid-content polyurethane resin compound, and a large amount of organic solvent is required such that the chlorine-free flameproof agent cannot fulfill its function because of the residual organic solvent. Moreover, the chlorine-free flameproof agent is generally oil-based and, thus, cannot be easily mixed with the water-based polyurethane resin compound due to poor compatibility therebetween, leading to stratification or deposition and, thus, not suitable for practical operation. Further, the process of coating the water-based polyurethane resin needs to be carried out by multiple coating that may be up to 10 times for coating a water-based polyurethane resin of 2 mm in thickness, for the water-based polyurethane resin has cracking problems during coating.

The present invention is therefore intended to obviate or at least alleviate the problems encountered in the prior art.

### SUMMARY OF INVENTION

It is an objective of the present invention to provide a method for making flameproof environmentally friendly artificial leather to significantly reduce the amount of organic solvent used and to render the artificial leather flameproof.

It is another objective of the present invention to provide a method for making flameproof environmentally friendly artificial leather to render the artificial leather durable and realistic.

To achieve the above-mentioned and other objectives, the present invention provides a method for making flameproof environmentally friendly artificial leather. Firstly, a flameproof polyurethane resin compound is prepared by mixing chlorine-free flameproof agent, an oil-based polyurethane resin and a curing agent, with the flameproof agent including an antimony-containing oxide, and with the oil-based polyurethane resin having 50%-98% by weight of solid content. A first polyurethane resin composition is coated on a releasing paper to form a surface layer with a thickness of 0.02 mm to 0.2 mm. Then, the flameproof polyurethane resin compound is coated on the surface layer to form a flameproof layer with thickness of 0.1 mm to 3 mm. A second polyurethane resin composition is coated on the flameproof layer to form an adhesive layer. Then, a substrate is adhered on the adhesive layer to form an environmentally friendly artificial semi-product. The releasing paper is peeled from the surface layer to form the flameproof environmentally friendly artificial leather.

Preferably, the chlorine-free flameproof agent is selected from a group consisting of antimony-containing flameproof agent, phosphorous flameproof agent, calcium carbonate and clay.

Preferably, the flameproof polyurethane resin compound is formed by mixing 10% to 25% by weight of chlorine-free flame-proof agent, 65% to 85% by weight of oil-based polyurethane resin with solid content of 93% to 98% by weight, 0% to 2% by weight of interface agent, 3% to 7% by weight of curing agent, and 0% to 10% by weight of dye.

Preferably, the flameproof layer has a thickness of 0.1 mm to 3 mm, and such a thickness can be obtained by a single coating procedure.

Preferably, the oil-based polyurethane resin has a solid content of 90% to 99% by weight.

Preferably, the first polyurethane resin composition is made of water-based polyurethane resin composition or water-dispersed polyurethane resin composition.

Preferably, the second polyurethane resin composition made of one of a water-based polyurethane resin composition, a water-dispersed polyurethane resin composition, and a solvent-free vapor-coagulated polyurethane resin composition.

In an embodiment, the flameproof polyurethane resin compound is baked at a temperature of 100° C. to 200° C. to form the flameproof layer. Moreover, foaming agent can be added to the flameproof polyurethane resin compound to render the flameproof layer porous. Preferably, the flameproof polyurethane resin compound is vacuum deaerated before it is coated.

In an embodiment, the substrate may be woven cloth, non-woven cloth or animal leather. The thickness of the substrate is 0.5 mm to 3 mm. The substrate can be processed with 5% to 50% by weight flame-resisting agent to improve the flameproof ability of the artificial leather.

Other objectives, advantages and novel features of the invention will become more apparent from the following detailed description in conjunction with the drawings.

### BRIEF DESCRIPTION OF DRAWINGS

The present invention will be described through detailed illustration of the preferred teachings referring to the drawings.

FIG. 1 is a flowchart of a conventional method for making artificial leather.

FIG. 2 is flowchart of a method for making flameproof environmentally friendly artificial leather according to the preferred teachings of the present invention.

FIGS. 3a to 3e are cross-sectional views of artificial leather made according to the method shown in FIG. 2.

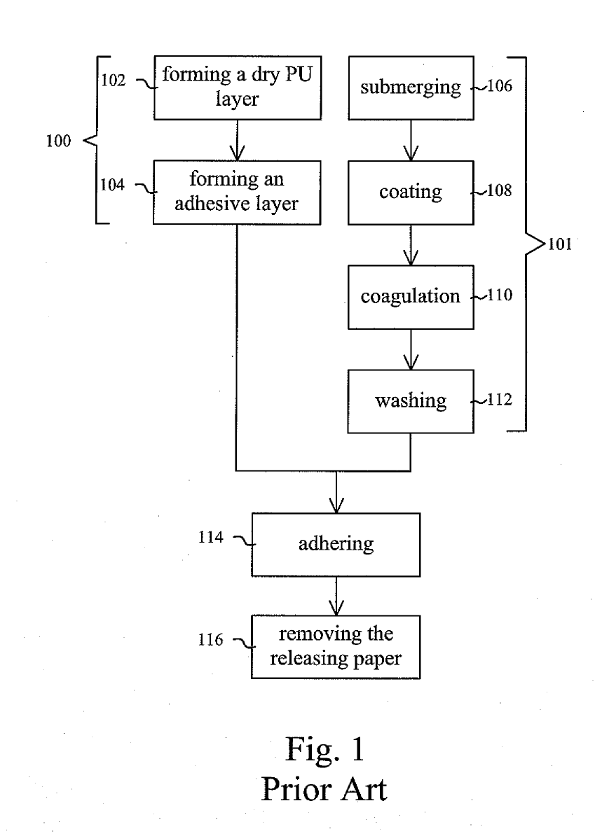

### DETAILED DESCRIPTION OF PREFERRED TEACHINGS

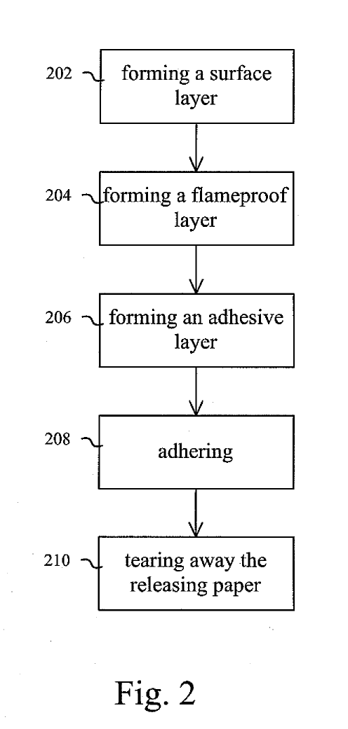

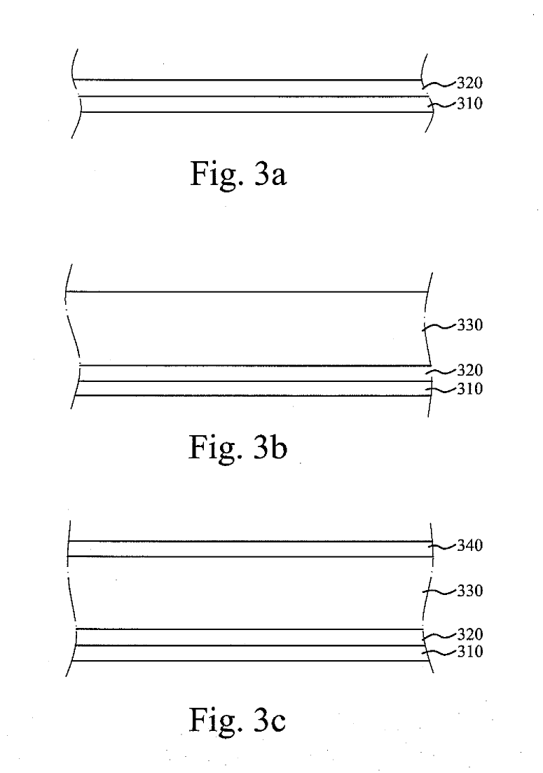

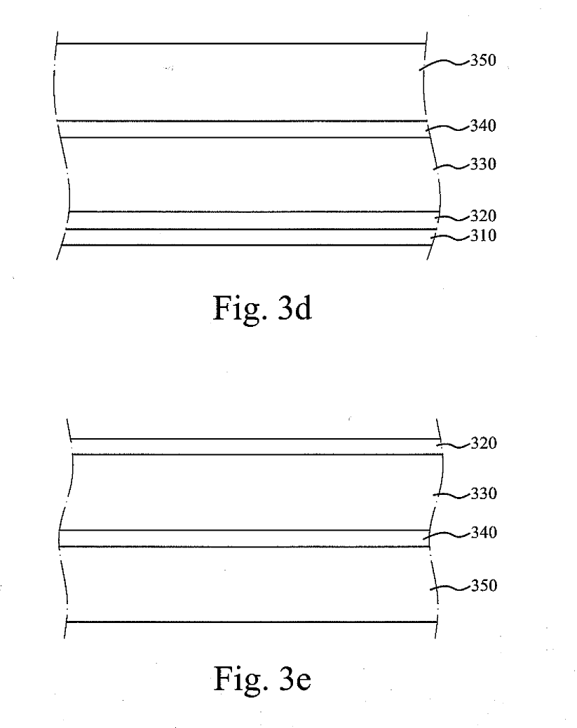

A method for making flameproof environmentally friendly artificial leather according to the preferred teachings of the present invention will be described with reference to FIGS. 2 and 3a to 3e.

Firstly, a first polyurethane resin composition is coated on releasing paper 310 and baked to form a surface layer 320 (FIG. 3a, part 202). Then, a flameproof, oil-based, high solid-content polyurethane resin compound is coated on the surface layer 320 and baked to form a flameproof layer 330 (FIG. 3b, part 204). A second polyurethane resin composition is coated on the flameproof layer 330 and then baked and coagulated to form an adhesive layer 340 (FIG. 3c, part 206). A substrate 350 is adhered on the adhesive layer 340 to form an environmentally friendly artificial semi-product (FIG. 3d, part 208). The releasing paper 310 is then removed to make the flameproof environmentally friendly artificial leather (FIG. 3e, part 210).

In the present invention, the first polyurethane resin composition utilized to form the surface layer 320 is solvent-type polyurethane, water-based polyurethane resin composition or water-dispersed polyurethane resin composition. The second polyurethane resin composition utilized to form the adhesive layer 340 is solvent-type polyurethane, water-based polyurethane resin composition, water-dispersed polyurethane resin composition or solvent-free vapor-coagulated polyurethane resin. Appropriate water-based polyurethane resin may be solvent-free water-based polyurethane resin IMPRANIL DLS made by Bayer Chemical Co. Ltd. Appropriate water-dispersed polyurethane resin composition may be IMPRANIL DLP made by Bayer Chemical Co. Ltd.

The first polyurethane resin composition utilized to form the surface layer 320 is preferably 10% to 90% by weight and more preferably 35% to 60% by weight. The first polyurethane resin composition is baked at a temperature of 80° C. to 140° C. to form the surface layer 320 with thickness of 0.02 mm to 0.2 mm.

It should be noted that the flameproof, oil-based, high solid-content polyurethane resin compound is made by mixing chlorine-free flameproof agent, oil-based polyurethane with a solid content of more than 50% by weight and curing agent. The flameproof layer 330 having a thickness of 0.2 mm to 3 mm is much thicker than the surface layer 320 and the adhesive layer 340. Thus, it has a feeling of volume and is elastic. The appropriate flameproof polyurethane resin may be oil-based polyurethane resin with a solid content of more than 50% by weight and more preferably oil-based polyurethane resin with a solid content of more than 90% by weight. More specifically, the oil-based polyurethane resin compound includes 65% to 85% by weight of polyurethane with a solid content of 90% to 99% by weight, 0% to 2% by weight of interface agent, 3% to 7% by weight of curing agent, 0% to 10% by weight of dye and 10% to 25% by weight of chlorine-free flame-proof agent. The flameproof, oil-based, high solid-content polyurethane resin compound includes the interface agent to achieve excellent flatness and floating of the surfaces of the flameproof layer. The flameproof agent may be an antimony-containing flameproof agent, a phosphorous flameproof agent, calcium carbonate, clay or any mixture thereof.

The flameproof, oil-based, high solid-content (more than 90% by weight) polyurethane resin compound includes some organic solvent (less than 7% by weight). Thus, in making the flameproof layer 330, only a small amount of organic solvent will be vaporized such that the flameproof agent can fulfill its function. Moreover, the thickness of the flameproof, oil-based, high solid-content polyurethane resin compound changes only a little before and after it is dried. Therefore, the flameproof layer is made thick easily to exhibit the feeling of volume and the durability of genuine leather.

The substrate 350 is adhered to the adhesive layer 340 before the adhesive layer 340 is dried. However, the substrate 350 can be adhered to the adhesive layer 340 when the adhesive layer 340 is dried a little and remains sticky. As the substrate 350 is adhered to the adhesive layer 340, a semi-product of the flameproof environmentally friendly artificial leather is made. Preferably, the semi-product of the flameproof environmentally friendly artificial leather is put in a curing chamber for 24 hours to 48 hours so that the adhesive layer 340 forms a net-shaped bridge.

According to the preferred teachings of the present invention, oil-based chlorine-free flameproof agent is added to the oil-based, high solid-content polyurethane resin compound to form a flameproof layer much thicker than the surface layer and the adhesive layer. The oil-based, high solid-content polyurethane resin compound contains little organic solvent so that the added flameproof agent works well. The thickness of the high solid-content polyurethane resin compound changes only a little before and after it is dried. The flameproof layer is made thick to easily exhibit the feeling of volume and durability of genuine leather. The method according to the preferred teachings of the present invention requires little or no organic solvent and is flameproof, assuring human health and safety while providing environmental protection.

Furthermore, the oil-based flame-proof agent matches much better with the oil-based polyurethane resin compound such that the compatibility therebetween can be much better and the flame-resisting property will be improved. Further, the process of coating the oil-based polyurethane resin can be carried out quickly. For example, only a single coating procedure (one-time coating) of the oil-based, high solid-content polyurethane resin is required to obtain a thickness of 2 mm. Although the flame-resisting effect of the oil-based polyurethane resin compound formed by one-time coating has no much difference from that of the water-based polyurethane resin compound formed by multiple coating, one-time coating is more practical and more positive than multiple coating when taking material costs and product stability into consideration.

The present invention has been described through the detailed illustration of the preferred teachings. Those skilled in the art can derive variations from the preferred teachings without departing from the scope of the present invention. Therefore, the preferred teachings shall not limit the scope of the present invention defined in the claims.

1. A method for making a flameproof environmentally friendly artificial leather, the method comprising:
preparing a flameproof polyurethane resin compound by mixing chlorine-free flameproof agent with an oil-based polyurethane resin and a curing agent, with the flameproof agent including an antimony-containing oxide, with the oil-based polyurethane resin having 50%-98% by weight of solid content;
coating a first polyurethane resin composition on a releasing paper to form a surface layer;
coating the flameproof polyurethane resin compound on the surface layer to form a flameproof layer;
coating a second polyurethane resin composition on the flameproof layer to form an adhesive layer;
adhering a substrate on the adhesive layer to form an environmentally friendly artificial semi-product; and
peeling the releasing paper from the surface layer to form a flameproof environmentally friendly artificial leather.

2. The method according to claim 1, wherein preparing the flameproof polyurethane resin compound includes preparing the flameproof polyurethane resin compound by mixing the oil-based polyurethane resin and the curing agent with the chlorine-free flameproof agent selected from a group consisting of antimony-containing flameproof agent, phosphorous flameproof agent, calcium carbonate and clay.

3. The method according to claim 1, wherein preparing the flameproof polyurethane resin compound includes preparing the flameproof polyurethane resin compound by mixing 10% to 25% by weight of chlorine-free flame-proof agent a 65% to 85% by weight of oil-based polyurethane resin with solid content of 93% to 98% by weight, 0% to 2% by weight of interface agent, 3% to 7% by weight of curing agent, and 0% to 10% by weight of dye.

4. The method according to claim 1, wherein preparing the flameproof polyurethane resin compound includes preparing the flameproof polyurethane resin compound by mixing chlorine-free flameproof agent with the oil-based polyurethane resin having solid content of 90% to 99% by weight and the curing agent.

5. The method according to claim 1, wherein preparing the flameproof polyurethane resin compound includes preparing the flameproof polyurethane resin compound of 0.1-3 mm in thickness by mixing chlorine-free flameproof agent with the oil-based polyurethane resin with solid content of 90% to 99% by weight and the curing agent.

6. The method according to claim 1, wherein coating the flameproof polyurethane resin compound on the surface layer includes coating the flameproof polyurethane resin compound of 0.1-3 mm in thickness on the surface layer by a single coating procedure.

7. The method according to claim 1, wherein coating the first polyurethane resin composition on the releasing paper includes coating the first polyurethane resin composition made of water-based polyurethane resin composition or water-dispersed polyurethane resin composition on the releasing paper.

8. The method according to claim 1, wherein coating a second polyurethane resin composition on the flameproof layer includes coating the second polyurethane resin composition made of one of a water-based polyurethane resin composition, a water-dispersed polyurethane resin composition, and a solvent-free vapor-coagulated polyurethane resin composition on the flameproof layer.

9. The method according to claim 1, wherein adhering a substrate on the adhesive layer includes adhering the substrate made of one of woven cloth, non-woven cloth, and animal leather on the adhesive layer.
